(19) United States
(12) Patent Application Publication
(10) Pub. No.: US 2015/0355403 A1
(43) Pub. Date: Dec. 10, 2015

(54) DIRECTIONAL GRATING-BASED BACKLIGHTING

(71) Applicant: Hewlett-Packard Development Company, L.P., Fort Collins, CO (US)

(72) Inventors: Charles M Santori, Palo Alto, CA (US); David A Fattal, Palo Alto, CA (US); Kelley Elise Rivoire, Palo Alto, CA (US)

(21) Appl. No.: 14/763,577

(22) PCT Filed: Jan. 30, 2013
(86) PCT No.: PCT/US2013/023901

§ 371 Date: Jul. 27, 2015

(51) Int. Cl. F21V 8/00; G02B 5/18

(52) U.S. Cl. CPC G02B 6/0068; G02B 6/0036; G02B 6/0058; G02B 5/1819

(57) ABSTRACT

A directional grating-based backlight includes a light guide to guide light and three sets of diffraction gratings. The diffraction grating sets are to selectively couple out portions of light to be guided by the light guide. The light is to propagate within the light guide in three different propagation directions separated in angle by about 120 degrees. The sets of diffraction gratings are to couple out different portions of the guided light as substantially collimated light using diffraction coupling. The substantially collimated light is to be emitted from the directional grating-based backlight in substantially the same direction.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Among the most commonly found electronic displays are the cathode ray tube (CRT), plasma display panels (PDP), liquid crystal displays (LCD), electroluminescent displays (EL), organic light emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). In general, electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given the lack of an ability to emit light.

To overcome the applicability limitations of passive displays associated with emitted light, many passive displays are coupled to an external light source. The coupled light source may allow these otherwise passive displays to emit light and function substantially as an active display. Examples of such coupled light sources are backlights. Backlights are light sources (often panel light sources) that are placed behind an otherwise passive display to illuminate the passive display. For example, a backlight may be coupled to an LCD or an EP display. The backlight emits light that passes through the LCD or the EP display. The light emitted is modulated by the LCD or the EP display and the modulated light is then emitted, in turn, from the LCD or the EP display. Often backlights are configured to emit white light. Color filters are then used to transform the white light into various colors used in the display. The color filters may be placed at an output of the LCD or the EP display (less common) or between the backlight and the LCD or the EP display, for example.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1A illustrates a plan view of a directional grating-based backlight, according to an example consistent with the principles described herein.

FIG. 1B illustrates a cross sectional view of the directional grating-based backlight illustrated in FIG. 1A, according to an example consistent with the principles described herein.

FIG. 2 illustrates a top view of a triangular grating-based backlight, according to an example consistent with the principles described herein.

FIG. 3 illustrates a top view of a hexagonal grating-based backlight, according to an example consistent with the principles described herein.

FIG. 4 illustrates a block diagram of a two-dimensional (2-D) electronic display, according to an example consistent with the principles described herein.

FIG. 5 illustrates a flow chart of a method of electronic display operation, according to an example consistent with the principles described herein.

Certain examples have other features that are one of in addition to and in lieu of the features illustrated in the above-referenced figures. These and other features are detailed below with reference to the above-referenced figures.

### DETAILED DESCRIPTION

Examples in accordance with the principles described herein provide backlighting using diffractive coupling. In particular, backlighting of an electronic display described herein employs sets of directional diffraction gratings to couple light out of a light guide. The light coupled out of the light guide is light that is propagating in three different directions within the light guide. The directional diffraction gratings selectively couple the light from the light guide and provide that coupled light to the electronic display. For example, the diffractive coupling may source the coupled out light to the electronic display as a backlight. In some examples, the light propagating within the light guide (‘guided light’) includes three different colors of light, each color propagating in a different one of the three different directions. Three sets of directional diffraction gratings are employed to selectively couple out the three different colors of light.

According to various examples, a directional diffraction grating of the three sets is employed to couple light out of a light guide by diffractive coupling. The diffraction grating includes or is made up of features (grooves, ridges, holes, bumps, etc.) formed in a surface of the light guide. Various characteristics of the diffraction grating and the features thereof may be used to control one or both of a directionality of the directional diffraction grating and its wavelength or color selectivity. Characteristics include, but are not limited to, grating pitch (feature spacing), grating feature shape, grating feature size (e.g., groove or ridge width), and grating orientation, for example.

Herein, a ‘diffraction grating’ is defined as a plurality of features arranged to provide diffraction of light incident on the features. A ‘directional diffraction grating’ is a diffraction grating that provides diffraction selectively for light propagating in a predetermined or particular direction. Further by definition herein, the features of a diffraction grating are features formed one or both of in and on a surface of a material that supports propagation of light. The material may be a material of a light guide, for example. The features may include any of a variety of features or structures that diffract light including, but not limited to, grooves, ridges, holes and bumps on the material surface. For example, the diffraction grating may include a plurality of parallel grooves in the material surface. In another example, the diffraction grating may include a plurality of parallel ridges rising out of the material surface. A diffraction angle θₘ of light diffracted by a periodic diffraction grating may be given by equation (1) as:

$${θ}_{m} = {sin}^{- 1} ( \frac{m λ}{d} - sin {θ}_{i} ) \qquad ( 1 )$$

where λ is a wavelength of the light, m is a diffraction order, d is a distance between features of the diffraction grating, and θᵢ is an angle of incidence of the light on the diffraction grating.

In some examples, the plurality of features may be arranged in a periodic array. In some examples, the diffraction grating may include a plurality of features arranged in a one-dimensional (1-D) array. For example, a plurality of parallel grooves is a 1-D array. In other examples, the diffraction grating may be a two-dimensional (2-D) array of features. For example, the diffraction grating may be a 2-D array of bumps on a material surface. The features (e.g., grooves, ridges, holes, bumps, etc.) may have any of a variety of cross sectional shapes or profiles that provide diffraction including, but not limited to, one or more of a rectangular profile, a triangular profile and a saw tooth profile.

Herein, ‘diffractive coupling’ is defined as coupling of an electromagnetic wave (e.g., light) across a boundary between two materials as a result of diffraction (e.g., by a diffraction grating). For example, a diffraction grating may be used to couple out light propagating in a light guide by diffractive coupling across a boundary of the light guide. The diffractive coupling substantially overcomes total internal reflection that guides the light within the light guide to couple out the light, for example.

Further herein, a ‘light guide’ is defined as a structure that guides light within the structure using total internal reflection. In some examples, the term light guide generally refers to a dielectric optical waveguide that provides total internal reflection to guide light at an interface between a dielectric material of the light guide and a material or medium that surrounds that light guide. According to various examples, the light guide may be any of several light guides including, but not limited to, slab or plate optical waveguide guide.

Further still, as used herein, the article ‘a’ is intended to have its ordinary meaning in the patent arts, namely ‘one or more’. For example, ‘a grating’ means one or more gratings and as such, ‘the grating’ means ‘the grating(s)’ herein. Also, any reference herein to ‘top’, ‘bottom’, ‘upper’, ‘lower’, ‘up’, ‘down’, ‘front’, back’, ‘left’ or ‘right’ is not intended to be a limitation herein. Herein, the term ‘about’ when applied to a value generally means within the tolerance range of the equipment used to produce the value, or in some examples, means plus or minus 10%, or plus or minus 5%, or plus or minus 1%, unless otherwise expressly specified. Moreover, examples herein are intended to be illustrative only and are presented for discussion purposes and not by way of limitation.

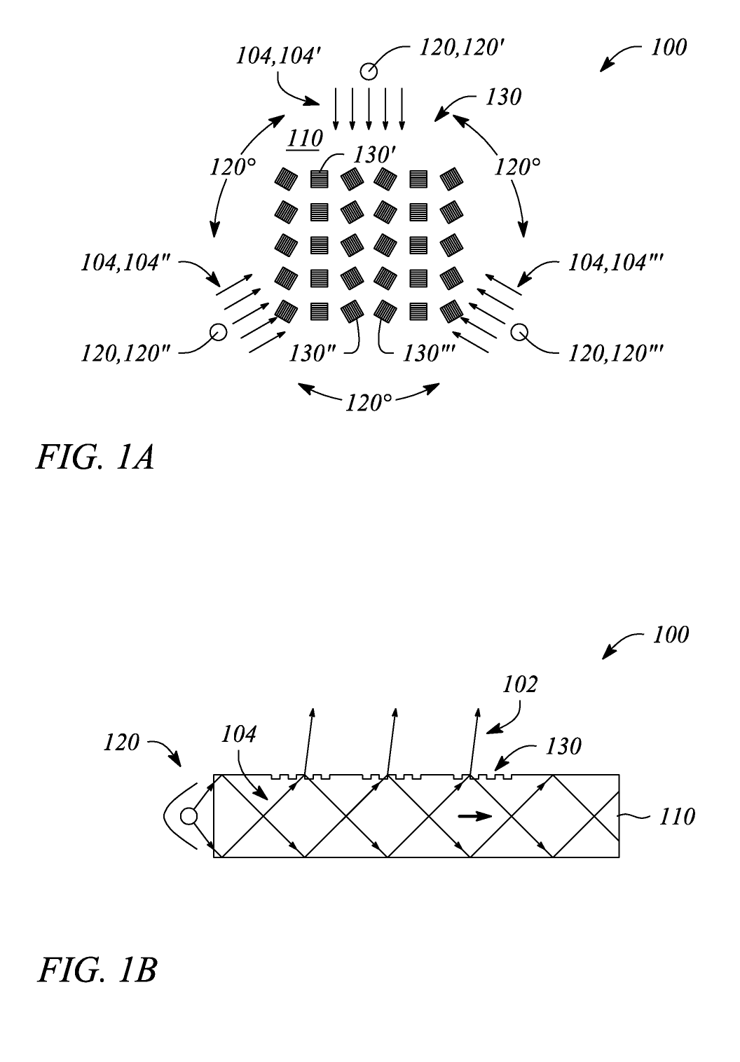

FIG. 1A illustrates a plan view of a directional grating-based backlight 100, according to an example consistent with the principles described herein. FIG. 1B illustrates a cross sectional view of the directional grating-based backlight illustrated in FIG. 1A, according to an example consistent with the principles described herein. According to various examples, the directional grating-based backlight 100 is configured to provide light to form a plurality of pixels of an electronic display. In some examples, the electronic display is a two-dimensional (2-D) electronic display. In other examples, the electronic display is a so-called ‘glasses free’ three-dimensional (3-D) display (e.g., a multiview display).

In particular, the directional grating-based backlight 100 may be configured to produce a plurality of light beams 102 (see FIG. 1B) that are substantially collimated and emitted in substantially the same direction (e.g., toward a viewing direction of the electronic display), according to various examples. Individual ones of the substantially collimated light beams 102 may correspond to individual pixels of the 2-D electronic display, according to some examples. The emitted light beams 102 may have both a predetermined direction and a relatively narrow angular spread, in some examples. In various examples, the emitted light beams 102 are configured to propagate in a direction away from the directional grating-based backlight 100 that is substantially perpendicular to a surface of the directional grating-based backlight 100. Collimation of the light beams 102 may reduce cross coupling or ‘cross-talk’ between adjacent light beams, for example. The reduced cross coupling may be particularly useful for 3-D display applications that are typically more sensitive to the effects of the cross coupling.

As illustrated in FIGS. 1A-1B, the directional grating-based backlight 100 includes a light guide 110. The light guide 110 is configured to guide light 104 (e.g., from a light source 120). In some examples, the light guide 110 guides the guided light 104 using total internal reflection. For example, the light guide 110 may include a dielectric material configured as an optical waveguide. The dielectric material may have a first refractive index that is greater than a second refractive index of a medium surrounding the dielectric optical waveguide. The difference in refractive indices may be configured to facilitate total internal reflection of the guided light 104 according to one or more guided modes of the light guide 110, for example.

For example, the light guide 110 may be a slab or plate optical waveguide that is an extended, substantially planar sheet of dielectric material (e.g., as illustrated in cross section in FIG. 1B and from the top in FIG. 1A). The substantially planar sheet of dielectric material is configured to guide the light 104 through total internal reflection. In some examples, the light guide 110 may include a cladding layer on a surface of the light guide 110 (not illustrated). The cladding layer may be used to further facilitate total internal reflection, for example. In some examples, the light 104 may be coupled into an end of the light guide 110 to propagate and be guided along a length of the light guide 110. One or more of a lens, a mirror and a prism (not illustrated), for example may facilitate the coupling of the light into the end of the light guide 110. According to various examples, the light guide 110 may include or be made up of any of a variety of dielectric materials including, but not limited to, various types of glass (e.g., silica glass) and transparent plastics (e.g., acrylic).

As further illustrated in FIG. 1B, the guided light 104 may propagate along the light guide 110 in a generally horizontal direction. Propagation of the guided light 104 is illustrated in FIG. 1A as a plurality of long arrows pointing away from the light source 120; and in FIG. 1B as a plurality of extended arrows representing various propagating optical beams within the light guide 110. The propagating optical beams illustrated in FIG. 1B may represent plane waves of propagating light associated with one or more of the optical modes of the light guide 110, for example. The optical beams of the guided light 104 are further illustrated in FIG. 1B as ‘bouncing’ or reflecting off of walls of the light guide 110 at an interface between the material (e.g., dielectric) of the light guide 110 and the surrounding medium to represent total internal reflection responsible for guiding the guided light 104.

According to various examples, the directional grating-based backlight 100 further includes three of such light sources 120 configured to provide the guided light 104, as illustrated in FIG. 1A. Each light source 120 of the three is disposed around the light guide 110 to introduce guided light 104 configured to propagate in a different one of three different directions. According to various examples, the three different directions have an angular separation of about 120 degrees (120°) from one another.

For example, as illustrated in FIG. 1A, a first light source 120′ may be configured to introduce guided light 104′ that propagates away from the first light source 120′ in a first direction. Further as illustrated, a second light source 120″ may be configured to introduce guided light 104″ that propagates away from the second light source 120″ in a second direction that differs from the first direction by 120 degrees (as illustrated). Further still, a third light source 120′″ may be configured to introduce guided light 104′″ that propagates away from the third light source 120′″ in a third direction that differs from both of the first direction by 120 degrees and the second directions by 120 degrees (as illustrated).

In various examples, the three light sources 120 may be substantially any source of light including, but not limited to, one or more of a light emitting diode (LED), a fluorescent light and a laser. In some examples, the light sources 120 may produce a substantially monochromatic light 104 having a narrowband spectrum denoted by a particular color. In particular, the color of the monochromatic light 104 may be a primary color of a particular color gamut or color model (e.g., a red-green-blue (RGB) color model). For example, the three light sources 120 may each include one or more LEDs, the LED of the first light source 120′ being a red LED, the LED of the second light source 120″ being a green LED, and the LED of the third light source 120′″ being a blue LED, for example. Hence, the monochromatic light 104 includes the separate colors red, green and blue provided separately by the three light sources 120. In some examples, the light sources 120 may each include a plurality of LEDs. The plurality of LEDs may be arranged in a strip as LED strips, for example, or another arrangement.

In various examples, the guided light 104 provided by the three light sources 120 is substantially directional. For example, light produced by the three light sources 120 may be introduced into the light guide 110 in a collimated manner so that the light propagates in the substantially directional manner away from each of the light sources 120. The guided light 104 propagating in the light guide 110 in the substantially directional manner is illustrated by a plurality of parallel arrows in FIG. 1A, for example. In some examples, a lens or a mirror (not illustrated) may be employed to collimate the light (e.g., from small-area light sources). In another example, light sources 120 may be a strip, a bar or plurality of individual light sources arranged in a row (e.g., a bar light or an LED strip) to provide the substantially collimated light.

According to various examples, the directional grating-based backlight 100 illustrated in FIGS. 1A and 1B further includes three sets of diffraction gratings 130. The three sets of diffraction gratings 130 are configured to couple out portions of the guided light 104 from the light guide 110 by diffractive coupling. According to various examples, each one of the three sets of diffraction gratings is to selectively couple out portions of the guided light 104 from a different one of the three light sources 120.

For example, as illustrated in FIG. 1A, a first set of diffraction gratings 130′ of the three sets may be configured to selectively couple out a portion of the guided light 104′ from the first light source 120′. A second set of diffraction gratings 130″ of the three sets may be configured to selectively couple out a portion of the guided light 104″ from the second light source 120″, for example. Additionally, a third set of diffraction gratings 130′″ of the three sets may be configured to selectively couple out a portion of the guided light 104′″ from the third light source 120′″, for example.

According to various examples, the three sets of diffraction gratings 130 may be arranged in a variety of configurations on a surface of the light guide 110 (e.g., a plane of the illustration of FIG. 1A). For example, the three sets of diffraction gratings 130 may be arranged in alternating or interspersed columns (e.g., separate interspersed columns for each of the three sets 130′, 130″ and 130′″, as illustrated in FIG. 1A). In another example, the three sets of diffraction gratings 130 may be arranged in alternating or interspersed rows. In another example, groupings including a diffraction grating 130 from each of the three sets may be located periodically across the light guide surface (i.e., each group may include a diffraction grating from each of the three groups). In yet another example, the diffraction gratings 130 of the three sets may be distributed substantially randomly or in another manner across the surface of the light guide 110.

According to various examples, diffractive coupling provided by the three sets of diffraction gratings 130 couples out portions of the guided light 104 from the three light sources 120 in a direction that is different from a direction of propagation within the light guide 110. For example, the coupled out portion of the guided light may be directed away from a surface of the light guide 110 at a diffraction angle relative to the light guide 110. The diffraction angle may be between 60 and 120 degrees, for example. As illustrated in FIG. 1B, the diffraction angle is about 90 degrees, for example. According to various examples, the coupled out portion of the guided light 104 is emitted as the light beams 102 (e.g., as illustrated in FIG. 1B). Also according to various examples, the diffraction angle of each diffraction grating 130 is substantially similar to the diffraction angle of every other diffraction grating 130 in the three sets. As such, the light beams 102 are emitted as substantially collimated light beams 102 that are directed in substantially the same direction away from the surface of the light guide 110, according to some examples.

According to various examples, the diffraction gratings 130 are located at a surface of the light guide 110. In particular, the diffraction gratings 130 of the three sets may be formed in a surface of light guide 110, in some examples. For example, a diffraction grating 130 of the three sets of diffraction gratings 130 may include one or both of grooves in a surface of the light guide 110 and ridges protruding from the light guide surface 110. The grooves and ridges may be arranged parallel to one another and substantially perpendicular to a propagation direction of the guided light 104 that is to be coupled out by the diffraction grating 130, for example.

In some examples, the grooves and ridges may be etched, milled or molded into the surface or applied on the surface. As such, a material of the diffraction grating 130 may include a material of the light guide 110, according to some examples. For example, as illustrated in FIG. 1B, the diffraction gratings 130 include parallel grooves that penetrate the surface of the light guide 110. In other examples (not illustrated), the diffraction gratings 130 may be a film or layer applied or affixed to the light guide surface. For example, the diffraction gratings 130 may be deposited on the light guide surface.

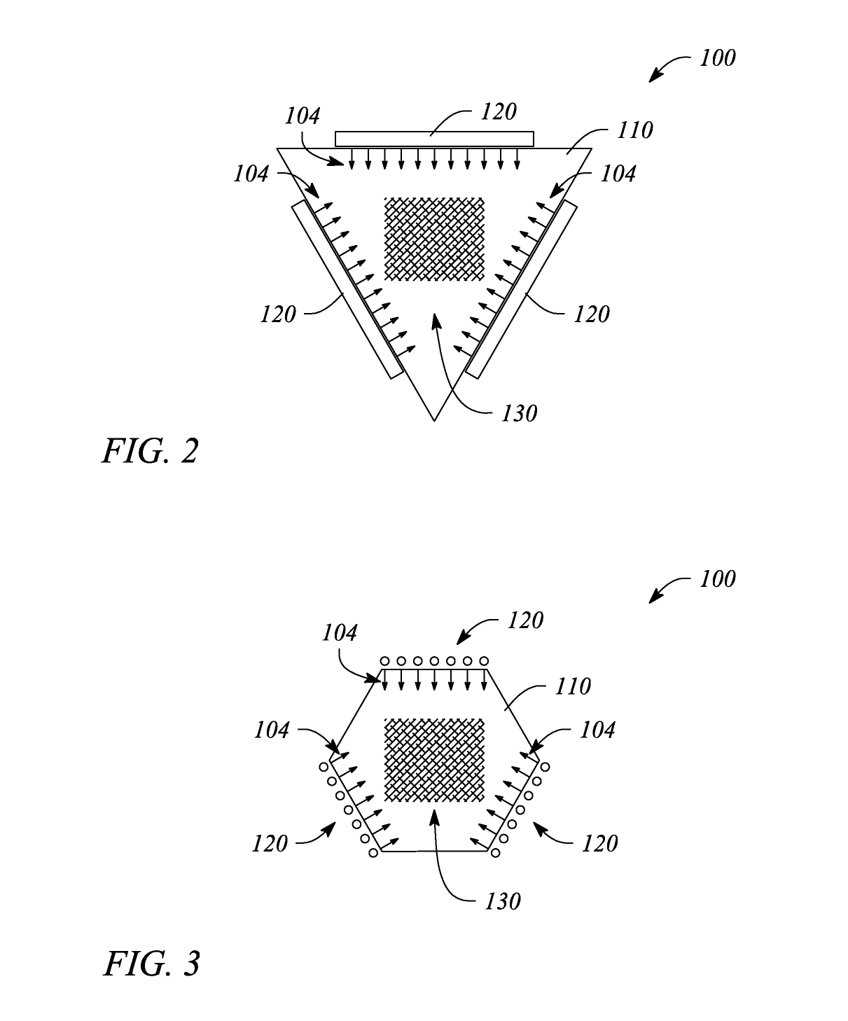

In some examples, the light guide 110 is shaped as a triangle and the directional grating-based backlight 100 is a triangular directional grating-based backlight 100. For example, the light guide 110 may be a planar optical waveguide shaped as a triangle. In some examples, the triangle shape may be substantially an equilateral triangle. FIG. 2 illustrates a top view of a triangular directional grating-based backlight 100, according to an example consistent with the principles described herein. According to some examples, the three light sources 120 are disposed along three different sides of the triangular light guide 110 to provide the guided light 104, as illustrated in FIG. 2, to the three sets of diffraction gratings 130 generally located on the planar surface of the triangular light guide 110. For example, strip LEDs may be positioned along the sides of the triangle to act as the three light sources 120. An example region on the planar surface of the triangular light guide 110 that may contain the diffraction gratings 130 is illustrated using cross-hatching in FIG. 2.

In some examples, the light guide 110 is shaped as hexagon and the directional grating-based backlight 100 is a hexagonal directional grating-based backlight 100. For example, the light guide 110 may be a planar optical waveguide shaped as a hexagon. In some example, the hexagon may be substantially a regular hexagon. FIG. 3 illustrates a top view of a hexagonal grating-based backlight 100, according to an example consistent with the principles described herein. According to some examples, the three light sources 120 (e.g., illustrated as plurality of LEDs) are disposed along three non-mutually adjacent sides of the hexagon to provide the 120 degree angular separation of the three directions of the guided light 104, as illustrated in FIG. 3. The three light sources 120 provide the guided light 104, as illustrated, to the three sets of diffraction gratings 130 located generally on the planar surface of the hexagonal light guide 110. Cross-hatching in FIG. 3 illustrates a region on the planar surface of the hexagonal light guide 110 that may contain the diffraction gratings 130, for example.

In some examples, the directional grating-based backlight 100 is substantially transparent. In particular, both of the light guide 110 and the three sets of diffraction gratings 130 may be optically transparent in a direction orthogonal to a direction of guided light propagation in the light guide 110, according to some examples. Optical transparency may allow objects on one side of the directional grating-based backlight 100 to be seen from an opposite side, for example.

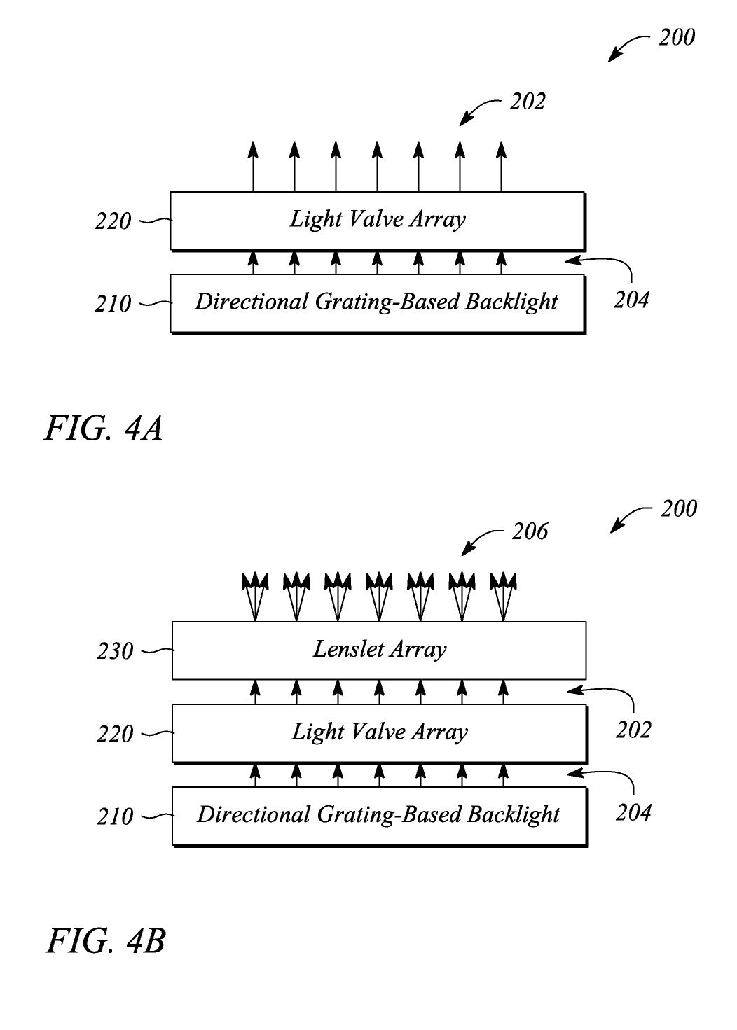

FIG. 4A illustrates a block diagram of an electronic display 200, according to an example consistent with the principles described herein. In particular, the electronic display illustrated in FIG. 4A is a two-dimensional (2-D) electronic display. According to various examples, the 2-D electronic display 200 is configured to emit modulated, differently colored light beams 202 as pixels of the 2-D display 200. Further, in various examples, the emitted modulated light beams 202 may be preferentially directed toward a viewing direction of the 2-D electronic display 200.

The 2-D electronic display 200 illustrated in FIG. 4A includes a directional grating-based backlight 210. According to various examples, the directional grating-based backlight 210 serves as a source of light for the 2-D electronic display 200. Further, the directional grating-based backlight 210 serves as a source of color for the 2-D electronic display 200. According to various examples, the directional grating-based backlight 210 may be substantially similar to the directional grating-based backlight 100, described above.

In particular, according to various examples, the directional grating-based backlight 210 may be a planar light guide configured to guide light. The guided light includes light of three different colors, according to various examples. Further, the three different colors of guided light are configured to propagate within the planar light guide in three different propagation directions separated in angle by about 120 degrees, according to various examples. In some examples, the planar light guide may be substantially similar to the light guide 110 described above with respect to the directional grating-based backlight 100. For example, the planar light guide may be a slab optical waveguide that is a planar sheet of dielectric material configured to guide light by total internal reflection. The planar light guide may have a triangular or a hexagonal shape, for example.

According to various examples, the directional grating-based backlight 210 further includes three sets of directional diffraction gratings to couple out portions of the guided light using diffractive coupling. Each of the three sets of diffraction gratings is configured to couple out portions of a different color of guided light. The portions are coupled out as a plurality of differently colored, substantially collimated light beams 204, according to various examples. In some examples, the three sets of diffraction gratings are substantially similar to the three sets of diffraction gratings 130 described above with respect to the directional grating-based backlight 100. For example, the diffraction gratings of the three sets may include one or both of a plurality of grooves in and a plurality of ridges on a surface of the light guide 210.

In some examples, the directional grating-based backlight 210 further includes three light sources. The three light sources are configured to provide the three different colors of guided light, according to various examples. According to some examples, the three light sources are substantially similar to the three light sources 120 described above with respect to the directional grating-based backlight 100.

In particular, the three light sources may be spaced from one another by about 120 degrees around the light guide. In some examples, a first light source of the three light sources may be a red light emitting diode (LED). In some examples, a second light source of the three light sources may be a green LED. In some examples, a third light source of the three light sources may be a blue LED. As such, the three different colors of light are red light, green light and blue light, according to some examples.

As illustrated in FIG. 4A, the 2-D electronic display 200 further includes an array of light valves 220. The light valve array includes a plurality of light valves 220 configured to modulate the differently colored, substantially collimated light beams 204 from the directional grating-based backlight 210, according to various examples. Further, according to some examples, different sets of the light valves 220 of the light valve array are configured to separately modulate different ones of the colors of light within the plurality of differently colored, substantially collimated light beams 204 coupled out by the diffraction gratings of the three sets in the backlight 210. In various examples, different types of light valves 220 in the light valve array may be employed including, but not limited to, liquid crystal light valves and electrophoretic light valves.

FIG. 4B illustrates a block diagram of another electronic display 200, according to an example consistent with the principles described herein. In particular, the electronic display illustrated in FIG. 4B is a three-dimensional (3-D) electronic display. According to various examples, the 3-D electronic display 200 is configured to emit a plurality of modulated, differently colored light beams 206 as pixels of the 3-D display 200. The light beams 206 that form pixels of the 3-D display 200 may be emitted in a plurality of different directions to provide a ‘glasses free’ (e.g., autostereoscopic) representation of information being displayed by the 3-D display 200, for example. However, while emitted in a plurality of different directions, the emitted modulated light beams 206 may be preferentially directed toward a viewing direction of the 3-D electronic display 200.

As illustrated in FIG. 4B, the 3-D electronic display 200 includes the directional grating-based backlight 210 and light valve array 220 of the 2-D electronic display described above with respect to FIG. 4A. The 3-D electronic display 200 further includes a lenslet array 230. The lenslet array 230 may include a plurality of lenses in a 2-D array, according to some examples. The 2-D array of lenses is configured to receive the modulated, differently colored light beams 202 emitted by the light valve array 220. The modulated, differently colored light beams 202 may be substantially collimated, for example. The lenslet array 230 is further configured to redirect the received light beams 202 to produce the light beams 206 that are emitted in the plurality of different directions, according to various examples.

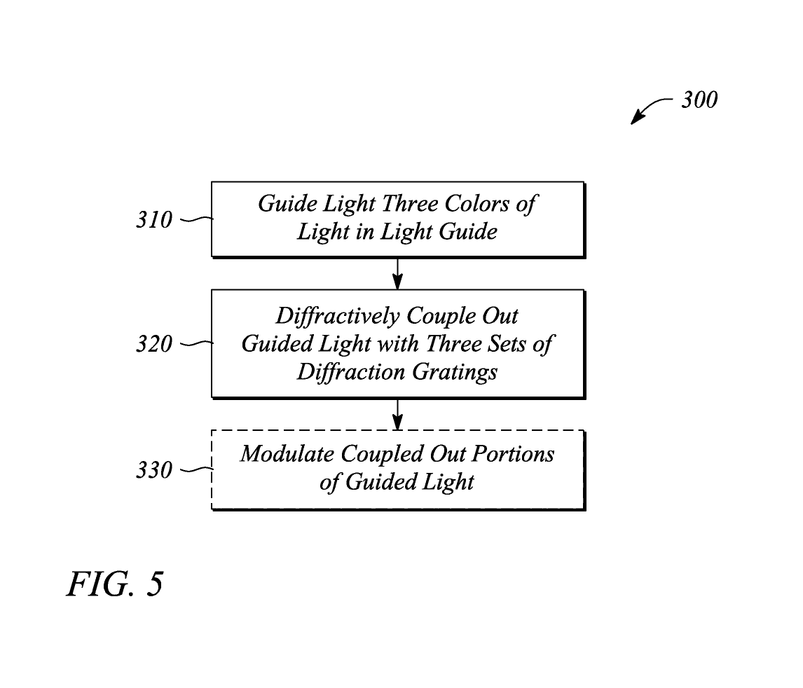

FIG. 5 illustrates a flow chart of a method 300 of electronic display operation, according to an example consistent with the principles described herein. As illustrated, the method 300 of electronic display operation includes guiding 310 three different colors of light in a light guide. In some examples, the light guide and the guided light may be substantially similar to the light guide 110 and guided light 104 described above with respect to the directional grating-based backlight 100. In particular, in some examples, the light guide may have either a triangular or a hexagonal shape. Further, the light guide may be a substantially planar dielectric optical waveguide, in some examples.

The method 300 of electronic display operation further includes diffractively coupling out 320 a portion of the guided light using three sets of directional diffraction gratings. According to various examples, each of the three sets of directional diffraction gratings is configured to selectively couple out portions of a different color of the guided light. For example, a first set of the directional diffraction gratings may be configured to selectively couple out portions of guided light of a first color; a second set of the directional diffraction gratings may be configured to selectively couple out portions of guided light of a second color; and a third set of the directional diffraction gratings may be configured to selectively couple out portions of guided light of a third color.

According to various examples, selective coupling may be facilitated by the directional nature of the directional diffraction gratings. For example, the diffraction gratings in each of the three sets may be rotated to be preferentially oriented in a direction to provide diffractive coupling of a color with which the diffraction gratings of the set are associated. The diffraction gratings of a first set may be rotated to face a first direction while diffraction gratings of the second set may be rotate 120 degrees with respect to the first set, for example. Similarly, the diffraction gratings of a third set may be rotated 120 degrees relative to both of the first set and the second set, for example.

Further, the diffraction gratings of each of the three sets may be tuned to preferentially respond to or select a particular color to further facilitate selective diffractive coupling 320. For example, a characteristic of the diffraction grating may be tailored to better match and thus to selectively provide diffraction of a particular color (i.e., color selectivity). Characteristics of the diffraction grating that may be used to provide color selectivity and facilitate selective diffractive coupling of a particular color include, but are not limited to, grating pitch (feature spacing), grating feature shape, grating feature size (e.g., groove or ridge width), and grating orientation.

According to some examples, the three sets of directional diffraction gratings used for diffractive coupling 320 may be substantially similar to the three sets of diffraction gratings 120 described above with respect to the directional grating-based backlight 100. For example, the diffraction gratings may be formed in or on a surface of the light guide. Further, in some examples, the colored light that is selectively and diffractively coupled out 320 is emitted by the directional diffraction grating as substantially collimated beams of light.

In some examples, the method 300 of electronic display operation further includes modulating 330 the coupled out portions of guided light. In some examples, the coupled out portions are modulated 330 using three sets of light valves corresponding to the three sets of directional diffraction gratings. The modulated 330 coupled out portions of the guided light may form colored pixels of a two-dimensional (2-D) electronic display, according to various examples. The colored light emitted as a pixel may be preferentially directed in a viewing direction of the electronic display, for example. In some examples, light valves used in modulating 330 the coupled out portions of guided light may be substantially similar to the light valves 220 of the light valve array described above with respect to the 2-D electronic display 200.

In some examples (not illustrated), the method 300 of electronic display operation further includes providing the three different colors of light using three light sources. According to various examples, the three light sources may be disposed around the light guide on three different sides to provide the 120-degree(120°) angle separation in the propagation directions of the colored guided light. For example the light guide may be triangular and the three light sources may be disposed on three sides of the triangle. In another example, the light sources may be disposed along three non-mutually adjacent sides of a hexagonal shaped light guide. In some examples, a first light source of the three light sources is a red LED, a second light source of the three light sources is a green LED, and a third light source of the three light sources is a blue LED. In these examples, the three different colors of the guided light are red, green and blue. In some examples, the three light sources may be substantially similar to the three light sources 120 described above with respect to the directional grating-based backlight 100.

Thus, there have been described examples of a directional grating-based backlight, an electronic display and a method of operating an electronic display that employ diffractive coupling of light from a light guide, wherein the light travels in three different directions within the light guide. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A directional grating-based backlight comprising:
a light guide to guide light;
three light sources disposed around the light guide to introduce the light to the light guide to propagate in different ones of three directions, the three directions having an angular separation of about 120 degrees; and
three sets of diffraction gratings adjacent a surface of the light guide to selectively couple out portions of the guided light from different ones of the three light sources as substantially collimated light using diffraction coupling,
wherein the substantially collimated light is to be emitted from the direction grating-based backlight in substantially the same direction.

2. The directional grating-based backlight of claim 1, wherein the light guide is a slab optical waveguide comprising a substantially planar sheet of dielectric material to guide the guided light by total internal reflection.

3. The directional grating-based backlight of claim 1, wherein the light guide is a planar optical waveguide shaped as either a triangle with the three light sources being disposed along three different sides of the triangle or a hexagon with the three light sources being disposed along three non-mutually adjacent sides of the hexagon.

4. The directional grating-based backlight of claim 1, wherein three light sources each comprises a light emitting diode (LED), the LED of a first light source of the three light sources being a red LED, the LED of a second light source of the three light sources being a green LED, and the LED of a third light source of the three light sources being a blue LED.

5. The directional grating-based backlight of claim 1, wherein a diffraction grating of a set of diffraction gratings of the three sets of diffraction gratings comprises one or both of grooves in a surface of the light guide and ridges protruding from the light guide surface, the grooves and ridges being arranged parallel to one another and substantially perpendicular to a propagation direction of the guided light to be coupled out by the set of diffraction gratings.

6. The directional grating-based backlight of claim 1, wherein a diffraction grating of each of a first set, a second set and a third set of the three sets of diffraction gratings comprises a feature spacing that differs from the feature spacing of the diffraction gratings of the other sets of diffraction gratings, the different feature spacing to selectively couple out a portion of guided light from a light source associated with the diffraction grating set.

7. The directional grating-based backlight of claim 1, wherein the light guide and the three sets of diffraction gratings are substantially transparent in a direction orthogonal to a direction in which the light is to be guided in the light guide.

8. An electronic display comprising the directional grating-based backlight of claim 1, wherein the portion of the guided light to be coupled out by a diffraction grating of the three sets of diffraction gratings is light corresponding to a pixel of the electronic display.

9. An electronic display comprising:
a directional grating-based backlight comprising:
a planar light guide to guide light of three different colors, the three different colors of guided light to propagate within the planar light guide in three different propagation directions separated in angle by about 120 degrees; and
three sets of directional diffraction gratings to couple out portions of the guided light using diffractive coupling, each of the three sets to couple out portions of a different color of guided light as a plurality of differently colored, substantially collimated light beams; and
a light valve array to modulate the differently colored, substantially collimated light beams,
wherein the modulated differently colored light beams are different pixels of the electronic display.

10. The electronic display of claim 9, wherein the directional grating-based backlight further comprises three light sources, a first light source of the three light sources comprising a red light emitting diode (LED), a second light source of the three light sources comprising a green LED, and a third light source of the three light sources comprising a blue LED, the three different colors of light being red light, green light and blue light, and wherein different sets of light valves of the light valve array are to separately modulate different ones of the colors of light within the plurality of differently colored, substantially collimated light beams to be coupled out by the diffraction gratings of the three sets.

11. The electronic display of claim 9, wherein the light valve array comprises an array of liquid crystal light valves, the electronic display being a two-dimensional (2-D) backlit liquid crystal display (LCD).

12. The electronic display of claim 9, further comprising a lenslet array to receive and redirect the modulated differently colored light beams, the modulated differently colored light beams being redirected in a plurality of different directions, wherein the electronic display is a three-dimensional (3-D) electronic display.

13. A method of electronic display operation, the method comprising:
guiding three different colors of light in a light guide, the three different colors of guided light propagating within the light guide in three different propagation directions separated in angle by about 120 degrees; and
diffractively coupling out portions of the guided light using three sets of directional diffraction gratings, each set of the three sets of directional diffraction gratings selectively coupling out portions of a different color of the guided light.

14. The method of electronic display operation of claim 13, further comprising modulating the coupled out portions of the guided light using three sets of light valves corresponding to the three sets of directional diffraction gratings, the modulated coupled out portions of the guided light forming colored pixels of a two-dimensional (2-D) electronic display.

15. The method of electronic display operation of claim 13, further comprising providing the three different colors of light from three light sources disposed around the light guide on three different sides, wherein a first light source of the three light sources comprises a red light emitting diode (LED), a second light source of the three light sources comprises a green LED and, a third light source of the three light sources comprises a blue LED, the three different colors of the guided light being red, green and blue.
